(19) United States
(12) Patent Application Publication
(10) Pub. No.: US 2007/0283379 A1
(43) Pub. Date: Dec. 6, 2007

(54) Audience Response System

(76) Inventor: Jeffrey Earl, Pevensey (GB)

Correspondence Address: ST. ONGE STEWARD JOHNSTON & REENS, LLC, 986 BEDFORD STREET, STAMFORD, CT, 06905-5619, US

(21) Appl. No.: 11/831,582

(22) Filed: Jul. 31, 2007

Related U.S. Application Data
(63) Continuation of application No. PCT/GB2006/000322, filed on Jan. 31, 2006.
(60) Provisional application No. 60/708,871, filed on Aug. 17, 2005.

(30) Foreign Application Priority Data
Jan. 31, 2005 (GB) 0501865.0

(51) Int. Cl. H04H 9/00

(52) U.S. Cl. 725/13; 341/22; 455/2.01

(57) ABSTRACT

An audience response system, an audience response keypad detection system and an audience response alert system. The audience response system includes a master unit and a plurality of RF linked keypads. The master unit includes a circuit controller that has a plurality of channel sets each of which includes two RF receiver channels, and a RF transmitter channel. Each of the keypads has a single channel set including two RF receivers, and a single RF transmitter. The detection system is arranged for detecting keypads and the alert system is arranged to issue alerts if the keypads pass into, through or out of a controlled area. The alert system can be used as a sentry system.

### CROSS-REFERENCE TO RELATED APPLICATIONS

The present application is a continuation of pending International patent application PCT/GB2006/000322 filed on Jan. 31, 2006, which designates the United States and claims priority from United Kingdom patent application GB 0501865.0 filed on Jan. 31, 2005 and U.S. Provisional Patent Application 60/708,871 filed on Aug. 17, 2005 the content of which is incorporated herein by reference.

### FIELD OF THE INVENTION

This invention relates to an audience response system and in particular to audience response apparatus for obtaining individual responses of audience members to a question put to them. In particular the invention relates to such an apparatus where a master unit communicates with a multiplicity of remote keypad units over a wired or wireless communications link.

The invention finds application in education, audio participation, game shows, voting at conferences and the like, and opinion polls.

### BACKGROUND OF THE INVENTION

A typical wireless audience response system comprises one or more master unit RF Transceivers that are connected to a central computer, and a number of keypad node RF transceivers that incorporate a simple keypad and display. The master unit transmits data representing a question to the keypads and each member of the audience enters their response to the question on their keypad and this is communicated to the master unit, on one or more RF channels also allocated to that controller.

Some prior known systems use protocols that send polling messages of one form or another from a master unit to one or more keypads, which then reply and are acknowledged as having replied. These protocols are commonly known as “acknowledged polling” protocols, and due to the polling overhead, they limit the number of keypads that can vote in a one second time period. There are prior known protocols that use one, or more, pairs of RF channels, one of each pair of channels being used purely for transmitting from the master unit and another of the pair of channels being used to transmit from the keypads to the master, or use a sequence of pairs of channels. Other prior known systems share a single RF channel, or use a sequence of channels, each of which is used for sending and receiving data.

A channel can be split into a number of time divisions to multiplex several responses together under a single poll request. This is normally done for legislative compliance, or to increase the number of keypads that can vote in a given block of time. In order to increase the number of keypads that can vote within a single second of time it is necessary to keep the transmission time for each keypad short and the delay between one keypad's transmission and the next short also. This delay is larger where a single master transceiver has to switch from transmit to receive and back again rapidly. For this reason some prior known systems have separate transmitters and receivers.

In theory, if a keypad transmits its vote randomly, it is likely that the vote would be heard by the receiving station, which could then transmit an acknowledgement. This would work for small number of keypads, or where the audience didn't all vote together, however, with larger numbers of keypads per channel, it is likely that the transmission from one keypad or the master unit could be corrupted by another transmission from another keypad or the master unit.

In typical wireless audience response system devices such as keypads are distributed throughout the audience. This distribution may be over a large area. If there are a lot of keypads and the area in which they are distributed is a large area, there is a chance of losing these devices or misplacing them. Since the devices are wireless they are easily removed from the vicinity of the area in which they are intended to be kept. Even if they are kept in the correct area they are likely to be moved from their original position to another position where their location may not be precisely known. The smaller devices the greater this problem becomes.

Also if there are many devices of a similar type each belonging to a different owner—for example if there are multiple audience response systems operating within the same area—there is a great likelihood of these devices becoming muddled up.

### SUMMARY OF THE INVENTION

An object of at least some embodiments of the present invention is to provide an audience response system to use a form of time division multiplexing so that keypads can transmit at specific times without requiring a specific polling signal from the master unit.

A further object of at least some embodiments of the present invention is to provide an audience response system with robust communications whilst imparting a minimal timing overhead for such robustness.

A further object of at least some embodiments of the present invention is to provided an audience response system that allows keypads and/or other wireless devices to be located.

A further object of at least some embodiments of the present invention is to provide an audience response system that can be operated to try to prevent keypads and/or other wireless devices from being removed from a certain area. According to a first aspect of the present invention there is provided an audience response system comprising a master unit and a plurality of remote keypad units. The master unit may comprise transmission means arranged for transmitting in a plurality of different channels. The transmission means may be arranged for simultaneous transmission of signals in a plurality of channels. The transmission means may be arranged for selective transmission of signals in one of a plurality of channels. The master unit may comprise receiver means arranged for receiving in a plurality of different channels. The receiver means may be arranged for simultaneous reception of signals in a plurality of channels. The receiver means may be arranged for selective reception of signals in one of a plurality of channels. Each keypad unit may comprise transmission means arranged for transmitting in a plurality of different channels. The transmission means may be arranged for simultaneous transmission of signals in a plurality of channels. The transmission means may be arranged for selective transmission of signals in one of a plurality of channels. Each keypad unit may comprise receiver means arranged for receiving in a plurality of different channels. The receiver means may be arranged for simultaneous reception of signals in a plurality of channels. The receiver means may be arranged for selective reception of signals in one of a plurality of channels. The master unit and/or each keypad unit may comprise at least one transmitter. The master unit and/or each keypad unit may comprise at least one receiver. The master unit and/or each keypad unit may comprise at least one transceiver. In some embodiments the or each transceiver may be arranged to operate both as a transmitter and a receiver. In other embodiments the or each transceiver may be arranged to operate respectively only as a transmitter or only as a receiver. Where distinct apparatus is provided for transmitting (a transmitter or a dedicated transceiver) and receiving (a receiver or a dedicated transceiver), there is the advantage that the apparatus does not have to switch between a transmit mode and a receive mode and this can help speed of operation.

Preferably each keypad unit comprises a transmitter and a pair of receivers. This can allow the reception of signals on two channels simultaneously. The transmitter in each keypad may be distinct from the receivers in the keypad. As mentioned above this can help increase operating speed. The master unit may comprise a plurality of channel sets each of which comprises a respective transmitter and a pair of receivers. The transmitters in the master unit may be distinct from the receivers in the master unit.

The master unit may be arranged to selectively vary the channel or channels used to transmit signals. The master unit may be arranged to selectively vary the transmission rate used to transmit signals.

Each keypad unit may be arranged to selectively vary the channel or channels used to transmit signals. Each keypad unit may be arranged to selectively vary the transmission rate used to transmit signals. Each keypad unit may have an associated address. This address may, for example, be a unique unit ID or an alias assigned to that keypad.

The master unit may be arranged to send configuration messages. Each keypad unit may be arranged to receive configuration messages. The configuration message may comprise one of, or a combination of: details of a time slot to be used for transmission and/or reception by a specified keypad unit; details of a channel which should be used for transmission and/or reception—this may be specific to a specified keypad or a general instruction; details of a transmission rate to be used for transmission—this may be specific to a specified keypad or a general instruction. Where a configuration message contains information to be acted on by a specific keypad unit, the configuration message may comprise the address of the keypad.

The master unit maybe arranged to monitor the behavior of the system. The master unit may be arranged to determine the content of configuration messages in dependence on the results of monitoring the behavior of the system. The master unit may be arranged to modify its operation in dependence on the results of monitoring the behavior of the system. The master unit may be arranged to vary the channel or channels to be used to transmit signals in dependence on the results of monitoring the behavior of the system. The master unit may be arranged to select the transmission rate to be used to transmit signals in dependence on the results of monitoring the behavior of the system. The results of these processes may be used in the master unit and/or included in configuration messages to control operation of the keypads. The audience response system may be arranged to use self-synchronizing time division multiplexing. The master unit and each keypad unit may comprise its own clock source and be arranged so that in any session, the first device, that is the master unit or one of the keypad units, to transmit uses its own clock source to determine the time at which it should transmit based on its allocated time slot and transmits a signal against which other devices can synchronize. The master unit and each keypad may be arranged so that during that session, another device, that is the master unit or one of the keypad units, which receives the signal, will synchronize to the first device. The audience response system may comprise a rebroadcast module for rebroadcasting signals after receipt thereof. The master unit may comprise the rebroadcast module, and in fact the same communications apparatus may be used for sending data signals and also possibly circuit management signals as for sending rebroadcast signals. Preferably, however, the rebroadcast module is distinct from the master unit.

More preferably still the rebroadcast module is located away from the master unit when the system is installed. The rebroadcast module may be located in a region which is known or suspected to be one where reception of signals from the master unit and/or each keypad unit is likely to be poor. Preferably the rebroadcast module is located in a “worst reception position”. This can be advantageous because an assumption can be made that if the rebroadcast module has received and rebroadcast, each other device in the system will have also seen the initial signal and received it if operational. The rebroadcast module may be arranged to rebroadcast signals with higher power than the other signals being transmitted in the system. The rebroadcast module may comprise a higher power transmitter than those in the keypad units and/or that in the master unit. Each keypad unit may be arranged so that when a keypad unit has a set of data to send, the keypad unit resends that set of data until that keypad unit receives the same set of data having been rebroadcast by the rebroadcast module.

The master unit may be arranged so that when the master unit has a set of data to send, the master unit resends that set of data until the master unit receives the same set of data having been rebroadcast by the rebroadcast module.

Where the master unit is arranged to monitor the operation of the system, the master unit may monitor the number of times that the master unit has to resend a set of data before receiving that set of data as rebroadcast by the rebroadcast module. In dependence on the number of times monitored, the master unit may change the data transmission rate and/or channel used. As discussed above these changes may be made for the transmissions of master unit and/or the keypad units.

According to another aspect of the present invention there is provided an audience response keypad unit for use in an audience response system as defined above. The audience response keypad unit may include any one of or any combination of the optional features defined above in relation to the first aspect of the invention, where context allows. According to another aspect of the present invention there is provided an audience response master unit for use in an audience response system as defined above.

The audience response master unit may include any one of or any combination of the optional features defined above in relation to the first aspect of the invention, where context allows.

According to yet another aspect of the invention there is provided a keypad unit for an audience response system comprising a casing within which is disposed a circuit board defining at least one aperture or cutaway portion which receives a component of the keypad unit. In this way the overall thickness of the casing can be reduced compared to the situation if the component was surface mounted on the circuit board. One internal dimension of the casing may be less than the sum of the thickness of the circuit board and the component.

According to a further aspect of the present invention there is provided an audience response keypad detection system for use in an audience response system.

According to a further aspect of the present invention there is provided an audience response keypad detection device for use in an audience response system.

The audience response keypad detection system may include any one of or any combination of the optional features defined above in relation to the first aspect of the invention where the context allows. It is to be understood that the keypad detection system may be capable of locating other devices for example other data notes that may not be keypads. Preferably, the keypad detection system comprises a keypad detection device. The keypad detection system may be arranged to communicate with one or more keypads so as to determine the location of the one or more keypads.

Preferably the system is arranged to locate keypads one at a time but it may be possible to locate more than one keypad simultaneously. Preferably, the keypad detection device is arranged to locate the keypads. The advantage of locating keypads one at a time is that the location operation is simplified and the technology required to perform it may be less complex. The advantage of locating keypads simultaneously is that a plurality of keypads located within the same area may be collected with greater efficiency by a user seeking to retrieve the collection of keypads. The keypad detection system may be arranged to determine the location of the one or more keypads on the basis of a measurement of RF signal strength. The keypad detection device maybe arranged to determine the location of the one or more keypads on the basis of a measurement of RF signal strength. The keypad detection system may be arranged to determine the location of the one or more keypads on the basis of a measurement of transmission timing. The keypad detection device may be arranged to determine the location of the one or more keypads on the basis of a measurement of transmission timing.

Transmission timing is defined as the time it takes for a signal to travel from a transmitting device to a receiving device, and is preferably a RF signal. Preferably, the keypad detection device is arranged to perform the measurement of RF signal strength or of transmission timing but other devices of the audience response system may be arranged to perform RF signal strength or transmission timing measurement. The RF signal strength or transmission timing that is measured is preferably that of the RF signals transmitted by the keypads, but could be the RF signals transmitted other devices of the audience response system. Such devices include keypad detection devices, keypads, master units, and/or other devices suitable for use with the audience response system which are capable of direct or indirect communication with the keypad detection system. Selected devices of the audience response system may each be arranged to perform measurement processing and/or communication with other devices so as to facilitate the location of the one or more keypads, for example, through radio triangulation techniques.

The keypad detection system may comprise a location indicator which is arranged to provide information concerning the location of the one or more keypads. The location indicator may be provided on a keypad detection device. The location indicator may be in a form of a display for example a dot matrix display or a text or number based display. The location indicator may be arranged to produce a series of lights or sounds that provides information concerning the location of the one or more keypads.

Preferably the location indicator is a range indicator which is arranged to display the proximity of the one or more keypads to the keypad detection device.

The keypad detection system may be arranged for allowing selection of the keypad that the user wishes to locate. The keypad detection device may be arranged for allowing selection of the keypad that the user wishes to locate. This may be through a mechanism of allowing the user to select or deselect keypads that are already found or are still lost. A mechanism by which keypad detection system locates specific keypads may be based on the ID of the keypad. The selection may be based on the fact that keypads that have already been found are switched off and/or registered with the master unit. The keypad detection system may be arranged to find only keypads that are still active and/or are within the close proximity of the keypad detection device. The mechanism of selecting which keypad may be found by the keypad detection system or device may be based on the fact that a keypad has moved outside a predetermined range from one or more master units. The predetermined range may be a maximum range for communication between the keypad and the master unit during normal operation. If the keypad moves beyond the predetermined range then it may be arranged to be activated, or it may be arranged to self activate to start emitting RF signals that will set it apart from other keypads within the predetermined range.

The RF signals emitted by a keypad that sets it apart from other keypads that are within the predetermined range of a master unit may be in the form of packets of data. Alternatively the RF signals emitted by the keypad to distinguish it from other keypads that have been removed from a certain range from a master unit may be in the form of signals communicated on a certain channel that may or may not be exclusive to those keypads. It is to be understood that the RF signals useable for distinguishing out of range keypads from keypads within the predetermined range and/or from other out of range keypads may be distinguishable by virtue of comprising one of or a of a combination of differentiating data signals, channels or other transmission characteristics.

The audience response keypad detection system may be arranged to measure a location parameter associated with a keypad whose location is to be determined. The audience response keypad detection device may be arranged to measure a location parameter associated with a keypad whose location is to be determined. When the location parameter of a keypad is measured, it may be used in the process of locating the keypad. The location parameter may be RF signal strength. The location parameter may be transmission timing.

The RF signal whose strength or timing is measured is preferably arranged to be transmitted from a keypad whose location is to be determined. The RF signal whose strength or timing is measured is preferably arranged to be received at a keypad detection device. Preferably, the strength or timing of the RF signal arranged to be received at a keypad detection device is arranged to be measured at the keypad detection device.

The keypad detection system may comprise a range scale changer. The keypad detection system may comprise a plurality of modes of operation. The range scale changer may be operable to change the mode of operation of the keypad detection system. The range scale changer may be operable to change the mode of operation of the keypad detection system from a first mode of operation to a second mode of operation.

Preferably, in a first mode of operation, the keypad detection system or keypad detection device is configured for use in determining the location of keypads which are located such that the location parameter associated with the respective keypad is on one predetermined side of a first threshold. In a second mode of operation, the keypad detection system or keypad detection device may be configured for use in determining the location of keypads located such that the location parameter of the respective keypad is on the other side of the first threshold. In the second mode of operation, the keypad detection system or device may be configured for use in determining the location of keypads which are located such that the location parameter of the respective keypad is on one predetermined side of a second threshold. The keypad detection system is preferably suitable for use in a mode of operation wherein the location indicator is arranged to provide a user with information that is useful in guiding the user to the location of the keypad that is being sought.

The resolution of the location indicator may be changed when the mode of operation of the keypad detection system is changed. Preferably, the first and second thresholds relate to areas that are of a different size. Other thresholds may relate to areas of other sizes. Changing the mode of operation of the keypad detection system or device may change the area in which the keypad detection system may be suitable for use. Where the location parameter is RF signal strength, the detection system or device, when in the first mode of operation, may be configured for locating keypads located such that the RF signal strength associated with the respective keypads is weaker than a predetermined RF signal strength threshold. When in the second mode of operation, the detection system or device may be configured for locating keypads located such that the RF signal strength associated with the respective keypads is greater than a predetermined RF signal strength threshold. Therefore when in the second mode of operation, the detection device or system is better suited to locating keypads that are physically closer to the detection device than in the first mode of operation. Where the location parameter is RF signal timing, the detection system or device, when in the first mode of operation, may be configured for locating keypads located such that the RF signal timing associated with the respective keypads is longer than a predetermined RF signal timing threshold. When in the second mode of operation, the detection system or device may be configured for locating keypads located such that the RF signal timing associated with the respective keypads is shorter than a predetermined RF signal timing threshold. Therefore when in the second mode of operation, the detection device or system is better suited to locating keypads that are physically closer to the detection device than in the first mode of operation. In some embodiments the operation of the location detector system will be the same in both modes of operation and merely the resolution of the location indicator will be different. However in other embodiments the location determining system will function differently in the two modes of operation. In such a case the first mode of operation the system will be arranged to be suitable for indicating the location of keypads which are further away from the detector than is the case when the device is in the second mode of operation.

An advantage of providing a range scale changer is that a plurality of resolutions may be represented on a single location indicator. In other words, if the same location indicator can be used in a plurality of modes, each mode being suitable for a different scenario, then the versatility of the detection system is increased.

The keypad detection system or device may also comprise a proximity indicator which may be incorporated as part of the location indicator or the same as the range indicator or may be a separate feature. The proximity indicator is operable to alert the user when a keypad device is in a predetermined proximity area around the keypad detection device. Such a proximity indicator may, for example, comprise a device that is operable to produce an audible alert or observable light. Alternatively, an altered state of the location indicator or the keypad detection device that is perceivable to the user may be used as a proximity indicator.

According to a further aspect of the present invention there is provided an audience response area alert system for use in an audience response system. According to another aspect of the present invention there is provided an audience response area alert device for use in an audience response system.

The audience response area alert system may comprise an audience response area alert device. The area alert system may be operable to generate an alert when a keypad is located such that a location parameter associated with the keypad is on one predetermined side of a threshold.

The audience response area alert system may include or may be used in conjunction with any one of or any combination of the optional features defined above in relation to the above aspects of the invention where the context allows. The audience response area alert device may be arranged to measure a location parameter associated with a keypad whose presence is to be determined. Alternatively, a keypad, whose presence is to be determined, may be arranged to measure the location parameter associated with the area alert system. When the location parameter of a keypad or any other device is measured, it may be used in the process of detecting the keypad. The location parameter may be RF signal strength. The location parameter may be RF signal transmission timing.

The RF signal whose strength or timing is measured is preferably arranged to be transmitted from an area alert device. The RF signal whose strength or timing is measured is preferably received and measured at a keypad whose presence is to be detected.

The keypad whose presence is to be detected by the area alert system or device may be configured to measure when the location parameter associated with the area alert device is on one side of a predetermined threshold. Preferably, the predetermined threshold is defined by a predetermined RF signal strength. The predetermined threshold may be defined by a predetermined RF signal timing. The predetermined RF signal strength or timing may be associated with an area centered on the device transmitting the RF signal.

It is to be understood that the shape of the area may be affected by many factors such as physical objects, RF interference and the transmission characteristics of the RF signals. For example, the shape of the area may be affected by the use of a directional antenna. In alternatives, the propagation direction of a received signal may be used as a location parameter. A directional antenna may be used in making such a measurement. The keypad may be arranged to be activatable and deactivatable. Preferably, the area alert system is arranged to respond to one or more keypads that are activated so that the alert is generated. The area alert system may be arranged not respond to keypads that are not activated. Preferably, the keypads are arranged to be activatable and/or deactivatable by a master unit. Alternatively, they may be arranged to be activatable and/or deactivatable by other devices, or may be self activatable and/or deactivatable. The audience response area alert system itself may be arranged to have an activated state and/or a deactivated state. Preferably it is the or each keypad which is arranged to produce the alert. This is advantageous because the user in possession of a keypad that is producing an alert will be directly informed by way of the alert that the keypad has moved into a position that is beyond the boundary of a predetermined range or at least be alerted to the fact that an alert is being produced while it is in the users possession—the natural instinct of the user would be to stop, query and/or return the keypad to its original location. Alternatively the system is arranged so that the alert is generated at a location away from the keypad for example at the area alert device, at the master unit or at other devices. Preferably, the system is arranged so that the alert may be generated at a device at or near the perimeter of the area of the predetermined range. An alert may be arranged to be generated at a device at or near an exit point (for example, a doorway in a room) from the area in which the keypads are normally contained. The advantage of producing an alert at a location that is away from the keypad is that a user that is more familiar with the operation of the audience response system may be alerted and can take the appropriate action. Furthermore, if an alert is arranged to be generated in the presence of an informed user then the alert generated maybe of a more discreet nature. This is advantageous because certain environments in which the audience response system is to be used such as meetings or presentations alerts of a disturbing nature (for example alarms) are less desirable. The alert may be arranged to contain information about the keypad that has been the subject of that alert. For example the keypad ID, the keypad location, or other keypad characteristics may be conveyed. It is possible that the system is arranged so that an alert may be generated at more than one location, for example one alert at the keypad and another alert at the master unit. These alerts may be of a different type.

The system may be arranged so that an alert may be generated by way of an audible signal, lights, a visible change on a display (for example computer screen readout) and/or any other change of state in any device of or linked to the audience response system that may be perceivable by a user.

### BRIEF DESCRIPTION OF THE DRAWINGS

The present invention will now be described, by way of example, with reference to the accompanying drawings, in which:

FIG. 1 shows schematically a system embodying the present invention.

FIG. 2 shows the circuit activity over time for the protocol of the present invention;

FIG. 3 shows data node packet transmission detail;

FIG. 4 shows use of a master circuit for inter-circuit packet routing;

FIG. 5 shows the cycle overview; and FIG. 6 schematically shows another system embodying the invention.

FIG. 7 shows a keypad detection device of a keypad detection system.

FIG. 8a shows a keypad detection device a long distance away from a keypad.

FIG. 8b shows a keypad detection device at an intermediate distance away from the keypad.

FIG. 8c shows a keypad detection device at a short distance away from the keypad.

FIG. 9 shows two keypads one of which is within a predetermined range of an area alert device and the other keypad outside that predetermined range.

### DETAILED DESCRIPTION OF THE INVENTION

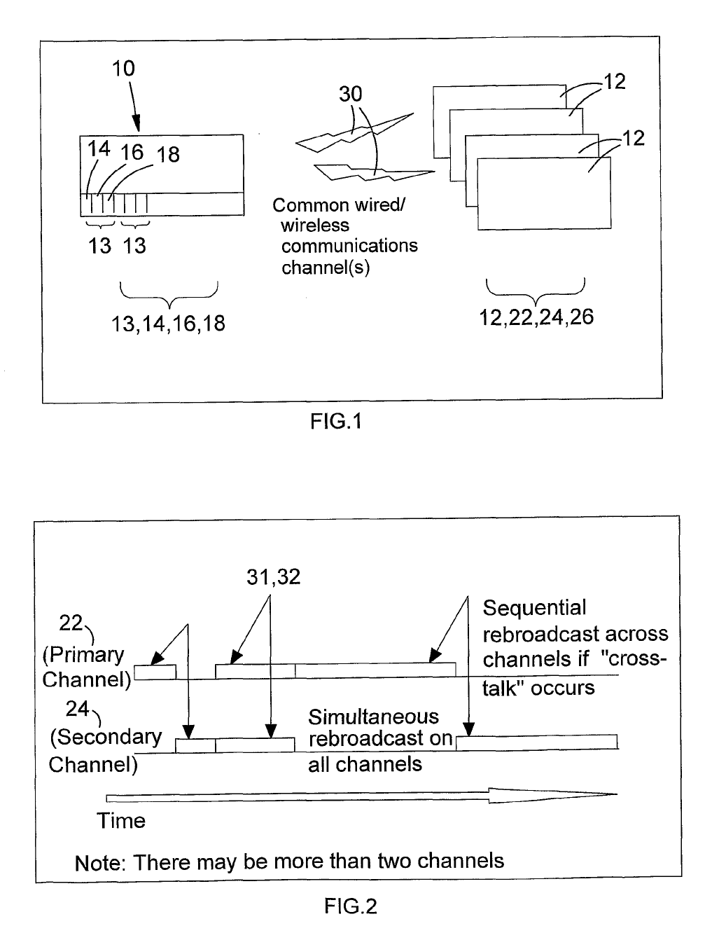

Referring to FIG. 1 there is shown a master unit 10 and a plurality of RF linked keypads 12. The master unit 10 comprises a circuit controller 20 that has a plurality of channel sets 13 each of which comprises two RF receiver channels 14, 16, and a RF transmitter channel 18. Each of the keypads 12 has a single channel set 13 comprising two RF receivers 22, 24, and a single RF transmitter 26.

Interference reduces the chance that a keypad vote would be heard. Therefore the receiving stations (the master unit 10 or the keypads 12, as the case may be) of the system of FIG. 1 uses positive acknowledgement procedures to reduce or eliminate losing the signals due to interference. A positive acknowledgement is desirable particularly and also to reduce the number of times that a keypad would have to retransmit its vote in order to guarantee receipt. These acknowledgement transmissions usually come from the master unit 10 after the keypads 12 have voted and reduce the time available for keypad voting.

If the same vote were transmitted on several channels then it is more likely that it would be heard. Further, interference may affect faster transmission signals but slower transmission may get through, so a fast and slow transmission rate would allow the largest number of keypads to communicate in a time period on a clear channel but increase the chances of those same keypads 12 communicating on a dirty channel, albeit over several time periods. Therefore the present invention incorporates a protocol that self synchronizes and self acknowledges across several channels, and switches transmission rates according to interference so as to enable the largest number of keypads 12 to vote in any time period whist offering the largest likelihood of those votes being successfully received by the master unit 10.

By incorporating a multiplicity of channel sets 13 each comprising a pair of receiver channels 14, 16 and one transmitter channel 18 into the master radio module 10, and two receivers 22, 24 and a transmitter 26 in each keypad 12, a keypad 12 and/or the master unit 10 has the ability to listen to two RF channels or to transmit on a single RF channel at the same time. It is desirable that the RF channels 22, 24, 26 have a degree of separation (typically 8 Mhz), because interference is likely to affect a contiguous block of several channels 22, 24, 26.

In order that the keypads 12 can be reconfigured dynamically, engineering information 33 (i.e. configuration messages) is sent from the master 10 to all of the keypads 12 at regular intervals, after several voting rebroadcast cycles. On detecting a key press (a vote) each keypad 12 listens on its primary and secondary channels 22, 24 respectively for a short period for any data messages or the engineering information (i.e. configuration messages). When this is heard, each keypad's time slot identification Code (ID) is used to calculate when the respective listening keypad's vote should be transmitted. The engineering information when received, specifies on which channel 26 to transmit and at what transmission rate.

The master 10 collates the votes, and after a predetermined voting time period has elapsed, that is equal to one time slot having passed for each keypad in the population, rebroadcasts them all on the, or each, of its primary 22 and secondary channels 24. Periodically this may be followed with engineering information relevant to the circuit controller, such as the data speed and transmission power that it expects and the group of keypads 12 that it is listening for.

The number of times a received vote is needed to be retransmitted before being received and successfully rebroadcast by the master 10, is used to determine the interference on that set of channels 22, 24, 26. If this is too high, then the master 10 uses the next engineering information data (configuration message) to switch the relevant keypad(s) to a slower transmission rate or switch to the next set of channels 22, 24, 26 in its channel schedule, and the relevant keypads 12 will follow—see below. Where a keypad 12 does not hear the engineering information, a vote or re-transmission of its own vote on either its primary or secondary channels 22, 24 it retries several times on both its primary and secondary channels 22 before switching to the next channel set 22, 24, 26 in its channel schedule. In this way, a vote will be transmitted several times on each channel 22, 24 in the schedule before the keypad 12 gives up, and the vote is lost; and a keypad 12 will automatically discover any new channel set 22, 24, 26 that its master 10 is working on.

Once a rebroadcast is heard by the keypad 12, the keypad 12 stops retransmitting its vote and uses that channel set 22, 24, 26 for the next vote.

Usually a keypad 12, will only listen to the master unit 10 if it has a vote to send, but a standby mode can be set where the keypad 12 periodically checks for engineering information 33 and changes channels accordingly to locate its master 10.

The engineering information 33 also allows a keypad 12 to determine when it has been removed from the vicinity of its master 10, and to start emitting tracking packets of data 34 at various power levels on one of several tracking channels 28 that a detecting device 29 can use to determine the range from it to that keypad 12. The tracking packets may also be produced in response to a specific command. The tracking channels may or may not be the same channels as used for the engineering and data transfer. The master 10, and the channel schedule that a keypad 12 works to, can be updated by issuing engineering information 33 for that keypad's unique identity (ID). The keypad 12 will adopt all of that engineering information 33. This specific “targeted” engineering information 33 would follow the usual engineering information 33 only when required, and the usual engineering information 33 would contain a flag that tells the keypads 12 that targeted or specific engineering information 33 follows on that occasion.

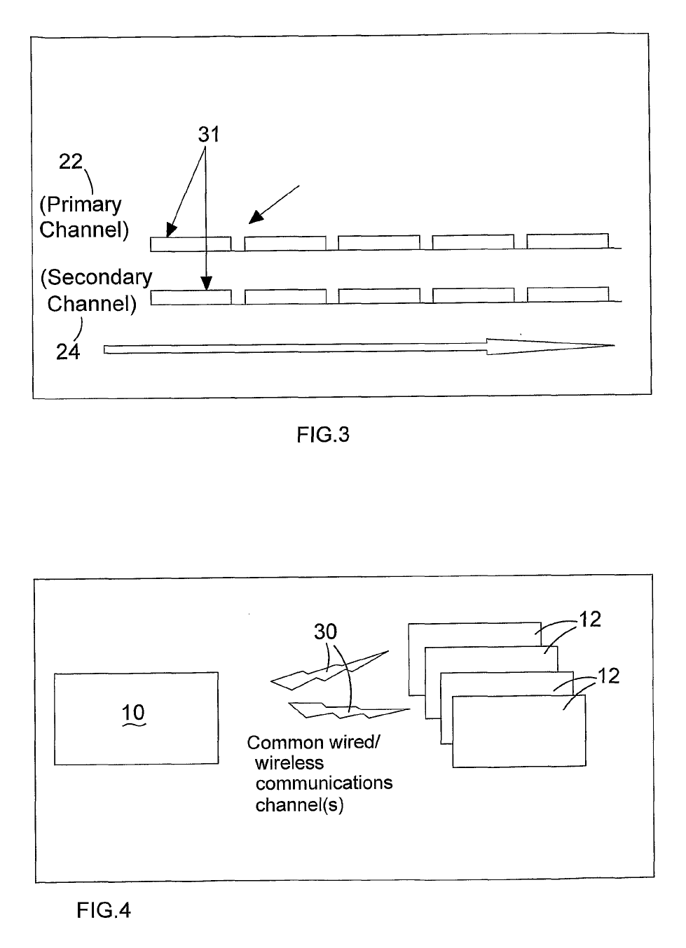

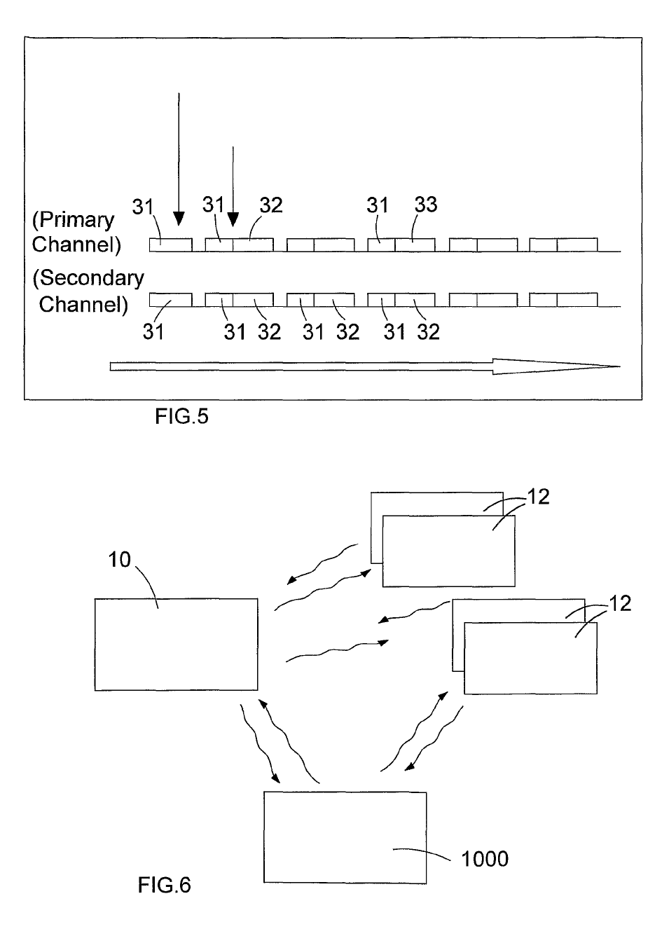

Referring in more detail to FIGS. 2 to 5 there is shown the protocol used by the master unit 10 and the keypads 12 of the present invention to communicate over a multiplicity of a mixture of wired and wireless communication links 30. It is to be understood that although the communication links 30 could be hard-wired links, the preferred system shown in the drawings uses wireless links 30.

Each message transmitted or received is broken into one or more identically sized packets 31 of data. The protocol is a self synchronizing, and self acknowledging multi path extension of the of a well known time division multiplexing protocol, and is “connectionless” in the sense that the data can be sent without first establishing contact with the data nodes 12 (i.e., Keypads 12) that will receive the message. Like TCP-IP datagram services, this also means that no guarantees are offered that the receiving station (master unit 10 or each keypad 12 as the case may be) is either listening or will receive the packet 31. However, as it is likely that the receiving station is either expecting the message, or will detect a message on its first transmission, and receive it on its subsequent rebroadcast, this is not seen as an impediment rather it offers efficiency. For convenience, the following description refers to the data transactions between one keypad 12 (node 12) but where the context permits, the same or a similar transaction takes place between the master unit 10 and each of the other nodes 12 in the network. Similarly there may be two or more Master Units 10 linked together each of which its own associated keypads 12. Again, only one master unit 10 is referred to below.

The delivery of a data packet 31 by a receiving station automatically acknowledged by the receiving station, in that each data packet 31 is rebroadcast in its entirety to the sending station. FIG. 6 schematically shows the system layout of another embodiment of the invention, which is similar to that described in relation to FIGS. 1 to 5 and is mentioned here because the difference lies in its rebroadcasting arrangement. In the FIG. 6 embodiment rebroadcast is carried out by a rebroadcast station 1000 that is distinct from the keypads 12 and master 10. In this case a sending station (keypad 12 or master 10) can deduce that there is a high degree of probability that the intended receiving station (keypad 12 or master 10) has received the data packet 31 once the sending station has received a rebroadcast message from the rebroadcast station 1000 as this means the rebroadcast station has successfully received and rebroadcast the data packet. This methodology and assumption is particularly valid if the rebroadcast station 1000 is placed in a “worst reception location”.

This protocol is automatically synchronising in that it has a high degree of predictability which allows each data node 12 to remain off-line unless it has a message to transmit, or is expecting to receive a message. By synchronising its on-board clock with any of the data packets 31, rebroadcast packets 32 or configuration information 33, a data node 12 can determine when to transmit, and over what period it should attempt to receive messages.

To aid synchronization, each data node 12 is able to hear all other transmissions, however, where this is not desired, an unsynchronized node 12 should listen for a configuration message 33 prior to making its own transmission.

Configuration transmissions 33 are made regularly as required by the ability of the data nodes 12 to maintain synchronization over a period of time. The configuration transmissions 33 also issue transmission times to any new data node 12. However where this is undesirable, the configuration transmissions 33 may be more infrequent. Any unsynchronized data node 12 should always listen, for an extended period in an attempt to receive the configuration messages 33 or other data packets 31 32 before sending its transmission anyway. The other data nodes 12 listen for transmissions would hear the transmission from the unsynchronized node, and the subsequent rebroadcast that is synchronized to that transmission and received and synchronizes the transmitted packets 31, 32; the rebroadcast station transmits the data packet 31,32 again at the newly synchronized position.

Preferably each data node 12 has a unique identifier (ID) that is known to the circuit controller 20 of the master unit such that the controller 20 can allocate a data node 12 to a selected time slot.

As a communications link 30 is established on one or more communications channels 22, 24 the circuit controller 20 must be able to receive on one or all of its receiver channels 26 simultaneously, but may only be able to transmit on one channel 22, 24 at a given time. Where the communication links 30 comprise a mixture of wired and wireless links, the controller 20 may have more than one transceiver; for handling wired communications and one for handling wireless communications separately. This is likely have a degree of self determination and be capable of buffering several inbound transmission, and of buffering several outbound transmissions, then releasing them at a given time.

The rebroadcast and configuration transmissions 32, 33 respectively, should happen simultaneously on all channels 22, 24, 26, However where a wireless link 30 is used, it may not be possible to do this due to the interference effects of co-located transmitters, so the transmission on those channels 22, 24, 26 would occur sequentially.

In FIG. 1 the circuit is managed by a single station 10 which initially, and then periodically, broadcasts configuration information 33 that includes the number of data nodes 12, such that a data node 12 can predict when its pre-allocated transmission time will be. Data packets 31, 32, 33, 34 from the data nodes 12 are transmitted on a single channel 22, or 24, and rebroadcast 32 on the other channel 22, or 24 (when acting as the rebroadcast station) as may be required. The data nodes 12 can predict when a rebroadcast will occur, and listen for their respective data packet 31, 33, the receipt of which denotes a successful transmission. The packets 32, 33 may be rebroadcast on its own transmission channels 22, 24 or on any, or all, of the channels 22, 24 used by the master unit 10. As a minimum, the packets 31, 32, 33 will be rebroadcast on those channels 22, 24, 26 that the original transmission was made, and the data node 12 addressed in the packet 31, 32, 33 last transmitted on. The receiving data node 12 therefore has the opportunity to receive, or to receive and verify, any data packets 31, 32, 33 addressed to it.

In case where the rebroadcast is not heard over several attempts, the data nodes 12 will listen on their secondary channel 24 several times for engineering messages 33 before changing to their next channel pair 22, 24 in any channel allocation schedule that is used for recovering from lost communications. In the wireless world this is common place and for wired connections it is likely that there exists a paring of a preferred physical link and a backup link.

For the purpose of identifying their time slot, data nodes 12 will synchronies with, in preferred order: a configuration transmission 33, then any rebroadcast transmissions 32, then any data transmissions 31.

If no rebroadcast 32 or other transmission 31, 33 is heard, the data node 12 transmits a request to the circuit controller in master unit 10 (address 0) for circuit configuration information 33 which the controller transmits to all nodes 12 after the rebroadcasts 32 have occurred.

Each data node 12 has a unique identification (ID). The circuit controller maintains a list of possible transmission times against the each data node's unique ID. It also maintains a list of channels 22, 24, 26 and unique IDs so that the controller can rebroadcast 32 on the correct channel 22, 24 for a given originator or addressee when the configuration of the system demands it.

In a first embodiment of the present invention, any addressee node 12 must remain in receive mode until it has got a message 31, 32. or 33. In a further embodiment of the invention, the rebroadcast station 10 or 12 as the case may be can determine the number of messages to be received by a data node 12 and transmit these first, in data node 12 order, with a time offset, for the first data packet 31, 32, 33 for a selected first data node 12. Each rebroadcast packet 32 must then include an offset to the next data packet 31, 32, 33 for that data node 12, effectively forming a data chain. Thus, although there is an extra set of transmissions, each data packet 14 is only rebroadcast once and at its original position, as expected by the transmitting data node.

The number of keypads 12 that a single circuit controller can handle is dependant only on the size of the keypad addresses (ID code) in the message packet 31, 32, 33. The longer the address portion of the packet the more likely that that packet will experience interference. Also a practical limit for the number of keypads 12 is also influenced by the response time that the audience is willing to wait for their vote to be recorded when voting. The longer that the audience is happy to wait for their vote to be communicated, the greater will be the number of keypads 12 that can vote in that period, or the more chances each keypad 12 has of voting several times in that period.

Also the practical number of keypads 12 that can be used will be dependant on the practical time interval expected by the master for receiving responses from all voters. This is particularly relevant in those voting circumstances where the winner is the person who is the fastest voter.

Each data packet 31, 32 transmitted over the channels 22, 23, 24 from the master has a preamble, an address of the intended recipient (e.g. keypad ID, Group ID, Session ID), the address of the sender and the data to be transmitted. Each data packet from each keypad 12 has a preamble, an address for the intended recipient (e.g. the master unit 10), the keypad ID, and the data to be transmitted (e.g. the vote).

More circuits can be attached to a central computer that constitutes the master unit 10. Where, two circuits may operationally use the same channels performance will be affected. When the number of circuits that can be used due to interference is exhausted, and more keypads 12 are required, they can be added to any circuit but there will be a longer time period, and consequently a vote will take longer to be communicated for extended circuits.

The components of the electronic circuits are designed to fit into a thin case that is about the size of a credit card. Some of the components, such as for example the display unit, would increase the thickness of the case if they were surface mounted on the front of the circuit boards, hi order to keep the thickness of the case as thin as possible, large components may be mounted in holes in the circuit boards so that the circuit boards lie intermediate the ends of the component, and the component connected to the circuit paths on a reverse side of the board instead of the front surface of the boards.

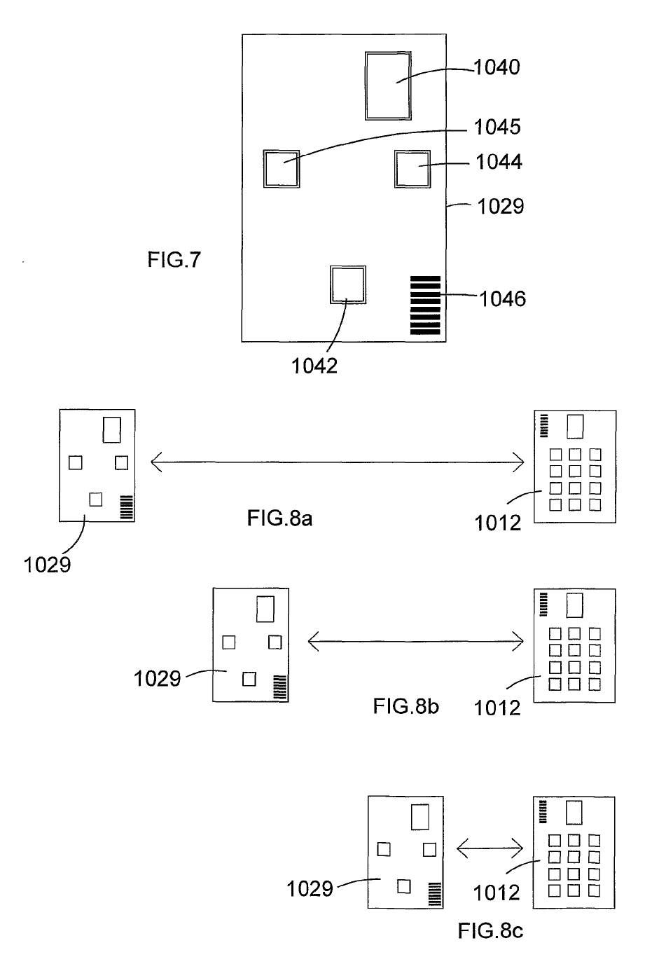

FIGS. 7, 8a, 8b, 8c and 9 show further embodiments of the present invention. Many features described above in relation to FIGS. 1 to 6 are also pertinent to the present embodiments, hi FIGS. 7 to 9 all reference numerals are in the thousands, where a feature in these Figures corresponds to a feature in one of the earlier Figures it is given a reference numeral that is 1000 higher than that given in the earlier Figures. For example, the keypads or data nodes 12 previously mentioned correspond to keypads 1012 referred to in FIGS. 7, 8a, 8b, 8c and FIG. 9.

FIG. 7 shows a keypad detection device of 1029 of a keypad detection system embodying of the present invention. In this embodiment the keypad detection device 1029 comprises all or nearly all of the features of the keypad detection system. In other embodiments however, the system may be more distributed. The keypad detection device 1029 is of a similar size as the keypads 12, 1012. Typically this size is the same size as a credit card. The keypad detection device 1029 comprises a power on button 1044 and a power off button 1045. Keypad detection device also comprises a range scale changer button 1042, a location indicator 1040 in the form of a range indicator 1040 which in this embodiment is a seven segment display which typically can display numbers between 0 and 9 although other representations are possible (for example, letters). The keypad detection device 1029 also comprises a proximity indicator in the form of an electronic alarm capable of producing an audible noise so as to alert the user of the keypad detection device 1029. The front surface of the range indicator 1040, the range scale changer button 1042 and the power buttons 1044, 1045 are substantially flush with the front surface of the keypad detection device. The proximity indicator 1046 is disposed within the casing of the keypad detection device. The alert generated by the proximity indicator 1046 is audible through the casing. There may be a series of holes on the rear surface of the keypad detection device casing to aid the transmission of sound. When the keypad detection device 1029 is used to locate one of the keypads 1012 it measures the strength of RF signals being transmitted by the keypad 1012.

As mentioned in reference to FIG. 1, a keypad 12, 1012 may start emitting tracking packets of data 34 at various power levels on one of several tracking channels 28 that the keypad detection device 1029 (or as mentioned earlier, the detecting device 29) can use to determine the range from it to the keypad 1012. The keypad 12,1012 starts emitting these tracking packets of data when it determines that it has been removed from the vicinity of its master unit 1010. It determines this by the fact that engineering information 33 sent from the master unit 1010 is no longer being received. In other words a keypad 12,1012 that moves outside the predetermined range enters a state where it “assumes it is lost” and so starts emitting tracking packets of data so that it can be “found” by the keypad detection device 1029.

Referring to FIG. 8 a there is shown a keypad detection device 1029 at a long distance away from a keypad 1012. The seven segment display acting as the range indicator 1040 on the keypad detection device 1029 represents the signal strength picked up by the keypad detection device 1029 in the form of a number. In this embodiment, the greater the number, the greater the signal strength measured and therefore the smaller the distance is between the keypad detection device 1029 and the keypad 1012 being sought.

In this embodiment the range indicator can indicate a number between 1 and 8 where “1” indicates lower signal strength than “8”. Therefore a reading of 1 on the seven segment display means that there is a large distance between the keypad detection device 1029 to the keypad 1012. As the keypad detection device 1029 is moved closer to the keypad 1012 the seven segment display 1040 will show a progressively increasing number indicating that the distance between the keypad detection device 1029 and the keypad 1012 is getting smaller. When the keypad detection device 1029 reaches a certain distance from the keypad 1012, the seven segment display 1040 shows a number 8 indicating that the detection device is an intermediate distance away from the keypad (see FIG. 8b). At this stage the user may press the range scale changer button 1042.

The range scale changer button 1042 changes the resolution at which the signal strength is measured and/or displayed. The device may change the way RF signal strength is measured (for example, using a different measurement/RF receiving means) or may simply, as is the case in this embodiment, display the signal strength that is measured using a different scale (using the same measurement/receiving means).

Thus if the user presses the range scale changer button, once at the intermediate distance, the number 8 shown by the seven segment display indicating distance/signal strength is changed to 1 and this value can increase back up towards 8 as the user moves the detector even closer to the keypad 1012 to be located. Thus the activation of the range scale changer button 1042 changes the scale from a long distance mode to a short distance mode. When the keypad detection device 1029 is within the intermediate distance of the keypad 1012 (as shown in FIG. 8b) the short range mode is more effective when the user is attempting to home in on the sought keypad 1012. FIG. 8c shows keypad detection device 1029 at a short distance from the keypad 1012. In this Figure, the scale has been changed to the short range and the number indicated on the seven segment display 1040 displays an 8. The user is therefore informed that the keypad being sought is a short distance away. Once at this close range, if the keypad detection device 1029 comes close enough to the keypad that is being sought, the proximity indicator 1046 on the keypad detection device 1029 is activated.

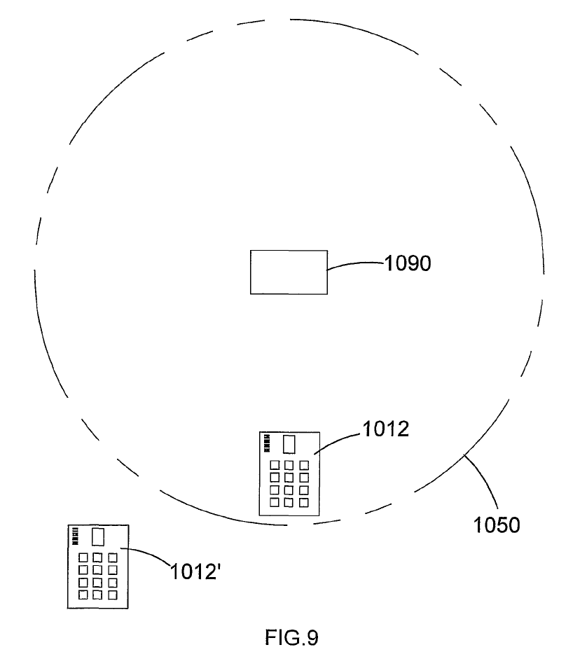

FIG. 9 shows an audience response system having an area alert system which comprises an area alert device 1090, a master unit (not shown) and two keypads 1012, 1012′. One of the keypads 1012 is within a predetermined range 1050 of the area alert device 1090 and the other keypad 1012′ outside that predetermined range 1050.

FIG. 9 shows a schematic representation of the predetermined range 1050 and may not be an accurate representation of a practical predetermined range. In this embodiment the predetermined range is defined by a predetermined RF signal strength as detected by the area alert system. The boundary defined by a predetermined RF signal strength may not be of a regular shape and could vary over time depending on a number of factors.

Each keypad 1012, 1012′ may adopt an activated state in which it is receptive to RF signals transmitted by the area alert device and a deactiviated state where it is not receptive to such signals. The master unit is arranged for issuing RF signals that when received by a keypad 1012, 1012′ put the keypad 1012, 1012′ in the activated state for use with the area alert device 1090. Similarly, the master unit is arranged for issuing RF signals that when received by a keypad 1012, 1012′ deactivate the keypad 1012, 1012′.

When in the activated state, the keypad will receive signals from the area alert device 1090 and if these signals are measured to be over a predetermined RF signal strength then the keypad 1012, 1012′ will generate an alert in the form of an audible alarm. The master unit may send information to the keypad 1012, 1012′ so as to set the RF signal strength threshold at which the alarm is set off.

As shown in FIG. 9, both keypads 1012, 1012′ are activated and one keypad 1012 is within the predetermined range 1050 whilst the other keypad 1012′ is outside the predetermined range 1050.

As it is activated and within the predetermined range, the RF signal strength measured by the first keypad 1012 will be greater than or equal to the predetermined RF signal strength defining the boundary of the predetermined range 1050. The keypad 1012 within this range will therefore generate an alarm. The other keypad 1012′ is outside the predetermined range 1050 and so the signal strength that it measures will be less than the signal strength threshold at which the alarm is activated and so no alarm will be generated. Once an alarm is activated, it may continue to be generated even if the keypad 1012, 1012′ is moved to a position where the RF signal strength is less than a predetermined threshold value.

The area alert system of FIG. 9 may be used as a “sentry” system. In particular a number of area alert devices 1029 may be provided and a respective one located at each of a corresponding number of exit points from a venue/room from which the keypads 1012 should not be removed. The predetermined range may be set such that a keypad 1012 cannot pass through one of the exit points from the venue/room without passing into the predetermined range area of one of the area alert devices 1029. That is the system can ensure that a keypad cannot be removed without an alarm being triggered. In alternatives, rather than an alarm being raised at the keypad it may be raised at the master unit (not shown), the area alert device 1029 or elsewhere.

In alternative embodiments, the distance between two communicating devices (for example, the keypad detection device 1029 and one of the keypads 1012) can be determined by way of measurement of the transmission time of RF signals from the transmitting device to the receiving device. Typical timing characteristics are 33 us for IOOM at 2.4 GHz RF at IW.

1-77. (canceled)

78. An audience response system, comprising:
a master unit including a transmitter for sending at least one master signal on at least one of a plurality of channels;
a plurality of keypads, each keypad including a transmitter for sending a keypad signal on at least one of the plurality of channels, the keypad signal sent by each keypad following the master signal in a time slot corresponding to the keypad, and two receivers for receiving the master signal on at least one of the plurality of channels;
a rebroadcast module for receiving and sending at least one of the master signal and the keypad signals; and
wherein said master unit further includes at least two receivers for receiving the keypad signals and the rebroadcast signals on the plurality of channels.

79. The audience response system according to claim 78, wherein said rebroadcast module is located remote to said master unit.

80. The audience response system according to claim 78, wherein said master unit comprises said rebroadcast module.

81. The audience response system according to claim 78, wherein said rebroadcast module has a signal transmission power greater than signal transmission powers of each of said master unit and said plurality of keypads.

82. The audience response system according to claim 78, wherein the transmitter of each keypad resends the keypad signal until at least one of the receivers of the keypad receives the keypad signal from said rebroadcast module.

83. The audience response system according to claim 78, wherein the transmitter of said master unit resends the master signal until at least one of the receivers of said master unit receives the master signal from said rebroadcast module.

84. The audience response system according to claim 78, wherein the time slot is synchronized from at least one of the master signal and a keypad signal of another one of said plurality of keypads.

85. The audience response system according to claim 78, wherein the time slot for each keypad is determined by the particular keypad based on a slot ID of the keypad.

86. The audience response system according to claim 78, wherein the keypad signal is indicative of a vote received via the keypad.

87. The audience response system according to claim 78, wherein said rebroadcast module sends each of the keypad signals after a predetermined voting time period has elapsed.

88. The audience response system according to claim 78, wherein the predetermined voting time is equal to one time slot having passed for each of the plurality of keypads.

89. The audience response system according to claim 78, wherein the master signal includes a configuration message including one of the plurality of channels and a transmission rate.

90. The audience response system according to claim 78, wherein said master unit is adapted to selectively vary at least one of the channels used to transmit signals and transmission rate used to transmit signals.

91. The audience response system according to claim 78, further comprising:
at least one keypad detection device for determining a location of each of the plurality of keypads.

92. The audience response system according to claim 78, further comprising:
at least one area alert device for generating an alert signal if a keypad exceeds a predetermined distance from said alert device.

93. The audience response system according to claim 78,
wherein said plurality of keypads includes two or more groups of keypads; and
wherein said master unit sends a first master signal for a first group and at least one second master signal for at least one second group.

94. The audience response system according to claim 93, wherein each of the at least one master signals includes a group ID corresponding to one of the two or more groups of keypads.

95. A method of wirelessly communicating with a plurality of remote keypad units, comprising the steps of:
receiving a vote via one or more of a plurality of remote keypad units;
sending a signal from a master unit to the plurality of keypads;
sending the vote from each of the one or more keypads in time slots determined for each of the particular keypad units;
receiving each of the votes by the master unit; and
rebroadcasting each of the votes from a rebroadcast module in the time slots after a predetermined voting time period has elapsed.

96. The method according to claim 95, wherein each keypad resends its keypad signal until the keypad unit receives its keypad signal from said rebroadcast module.

97. The method according to claim 95, wherein the master unit resends the master signal until the master unit receives the master signal from said rebroadcast module.

98. The method according to claim 97, further comprising the step of:
monitoring the number of times that the master unit has to resend the master signal; and
varying at least one of a channel and a transmission rate if the number reaches a predetermined number.

99. The method according to claim 95, wherein said signal is a configuration message, the configuration message including a channel and a transmission rate.

100. The method according to claim 95, further comprising the step of:
determining, on each keypad unit, the time slot based on a slot ID of the keypad unit.

101. The method according to claim 95, wherein said predetermined voting time period is equal to one time slot having passed for each of the plurality of keypad units.

102. The method according to claim 95, wherein the master unit receives each vote from the rebroadcasting module.

103. The method according to claim 95, wherein said rebroadcast module is distinct from the master unit.

104. The method according to claim 95, wherein said master unit comprises said rebroadcast module.

105. The audience response system according to claim 95,
wherein the plurality of keypad units includes two or more groups of keypad units;
wherein said master unit sends a first signal for a first group and at least one second signal for at least one second group; and
wherein each of the at least one signals includes a group ID corresponding to one of the two or more groups of keypad units.
